(19) United States
(12) Patent Application Publication
(10) Pub. No.: US 2002/0041791 A1
(43) Pub. Date: Apr. 11, 2002

(54) Connecting element

(76) Inventors: Frank Friedrich, Lemforde (DE); Thomas Burlage, Wallenhorst (DE)

Correspondence Address: BASF CORPORATION, LEGAL DEPARTMENT, 1609 BIDDLE AVENUE, WYANDOTTE, MI, 48192, US

(21) Appl. No.: 09/970,270

(22) Filed: Oct. 3, 2001

(30) Foreign Application Priority Data
Oct. 5, 2000 (DE) 10049323.8

(51) Int. Cl. B25G 3/28

(52) U.S. Cl. 403/359.1

(57) ABSTRACT

3 A connecting element comprises (i) sleeve, (ii) bearing element and (iii) core, where (ii) has in each case an interlocking connection on the outer surface of (ii) with (i) and on the inner surface of (ii) with (iii).

The present invention relates to connecting elements comprising (i) sleeve, (ii) bearing element and (iii) core, wherein (ii) has in each case an interlocking connection on the outer surface of (ii) with (i) and on the inner surface of (ii) with (iii).

Round bearings, which are also generally referred to as connecting elements in this document, are used for connecting oving axles or components, for example in the fastening of connecting rods in vehicle chassis. These connecting elements serve with transmitting force and movement between various components, for example connecting rods, and must prevent distortion of the total system in the case of statically overdetermined systems. This is effected, for example, by the use of elastomer springs between the moving components, for example the sleeve and the core, the elastomer absorbing and reducing stresses between sleeve and core. The connection between sleeve, elastomer spring and core is usually achieved by a chemical adhesion promoter. The disadvantage of this known design is the complicated production of the connecting element due to thorough cleaning of the parts before application of the adhesion promoter.

It is an object of the present invention to provide connecting elements which ensure an ideal connection with excellent force transmission between the components in combination with stress absorption. The connecting elements should be simple to produce and in particular permit easy recycling.

We have found that this object is achieved by the connecting elements described at the outset.

The contoured surfaces of (i), (ii) and (iii), each of which is connected to the other components, achieve interlocking between the components which permits excellent force transmission. The expression interlocked is to be understood as meaning that (i), (ii) and (iii) do not have a circular shape along the circumference around their common longitudinal axis. If (iii) is inserted or pushed into (ii) and (ii) with (iii) into (i) with the result that (i) and (ii) are centered about the longitudinal axis of (iii), a circular circumference of (ii) both on the outside facing (i) and on the inside facing (iii) would permit unrestricted rotational movement of (ii) in relation to (i) or (iii). This rotational movement has been limited to the required level to date by adhesion promoters. In the case of the novel embodiment, a chemical adhesion promoter is not required since the outer and inner surfaces of (ii) and the corresponding surfaces of (i) and (iii) are contoured, for example, by means of recesses or protuberances and the components (i), (ii) and (iii) can be fixed in one another and to one another by these contours. The contours can preferably be designed in such a way that (ii) and (iii) each have at least two edges, preferably parallel to the longitudinal axis of the component, which are positioned in corresponding grooves, preferably parallel to the longitudinal axis of the components, of (i) and (ii), respectively, and effect force transmission between (i), (ii) and (iii) during a rotational movement about the longitudinal axis of the connecting element. As a result of the novel interlocking of the components, the components (i), (ii) and (iii) need not be bonded by chemical reaction. Connecting elements in which (i) and (ii) are hollow, (ii) is positioned by being pushed into the cavity of (i) and (iii) is positioned by being pushed into the cavity of (ii), and (ii) and (iii) are capable of performing only the functionally required maximum rotational movement in relation to (i) about the longitudinal axis of the cylindrical connecting element are preferred.

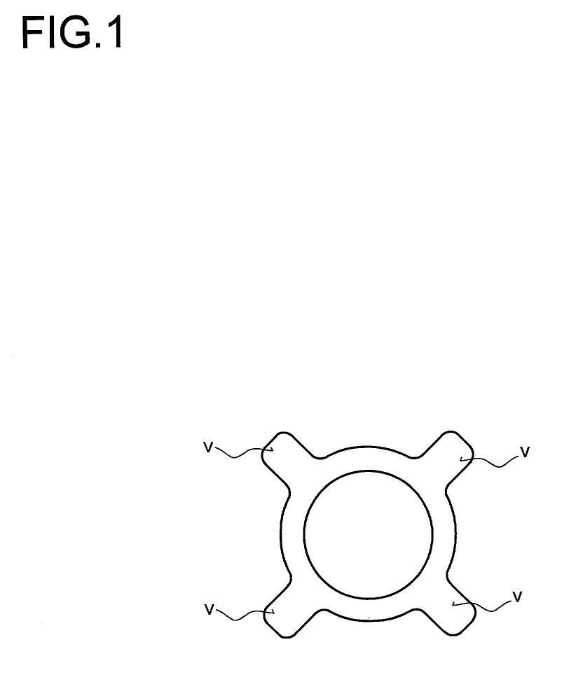

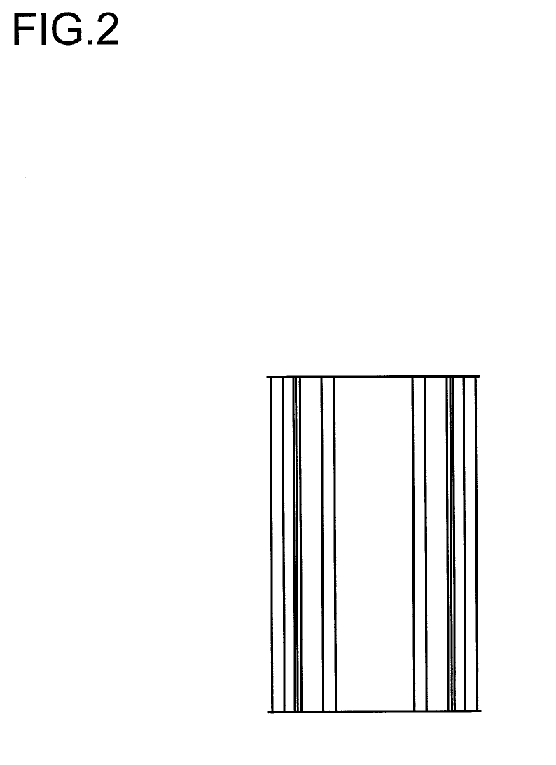

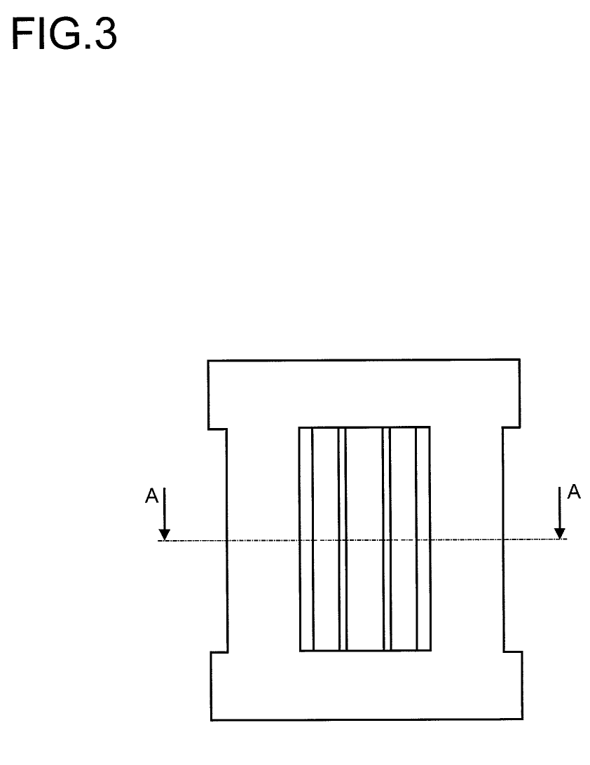

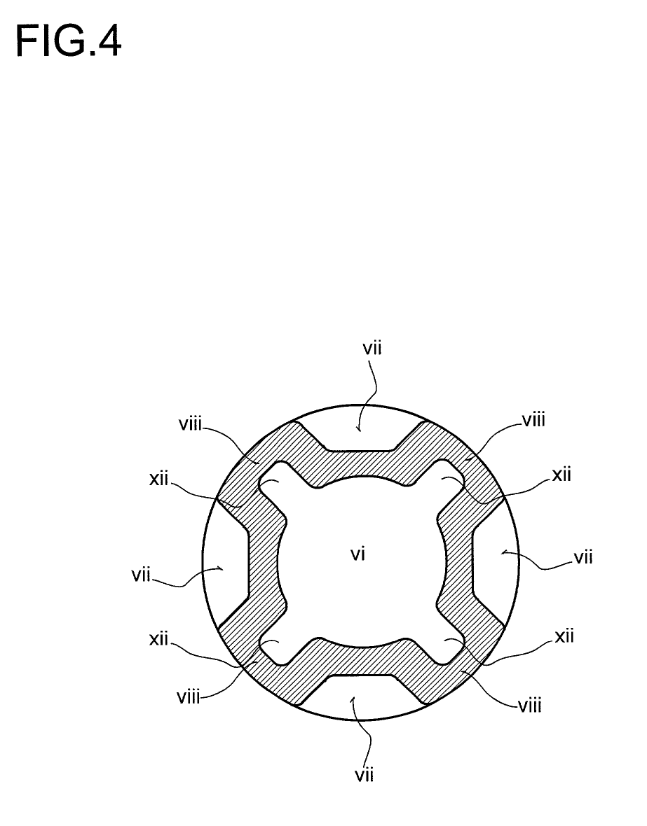

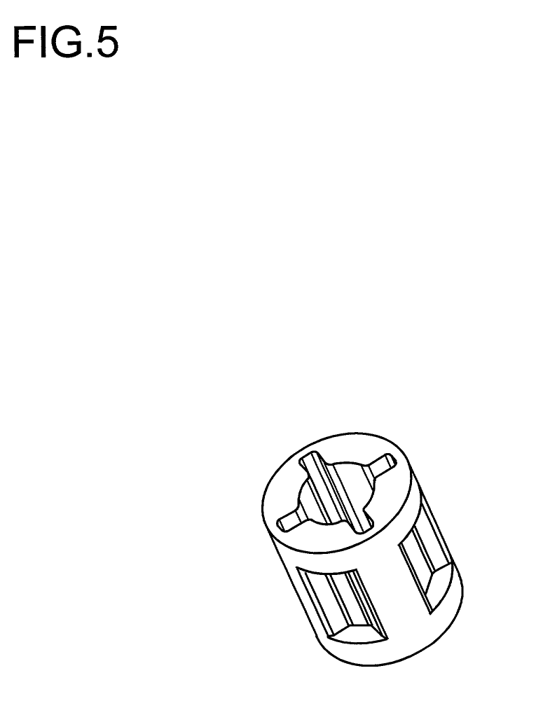

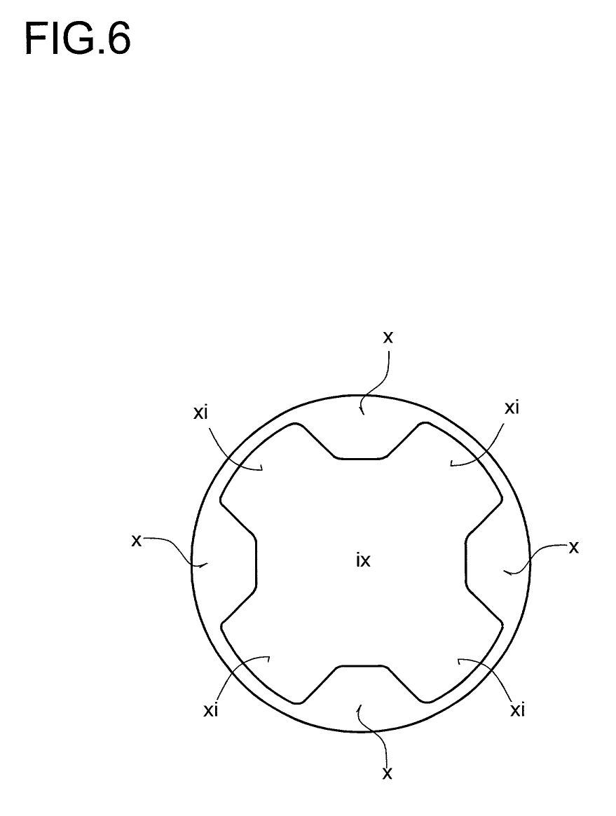

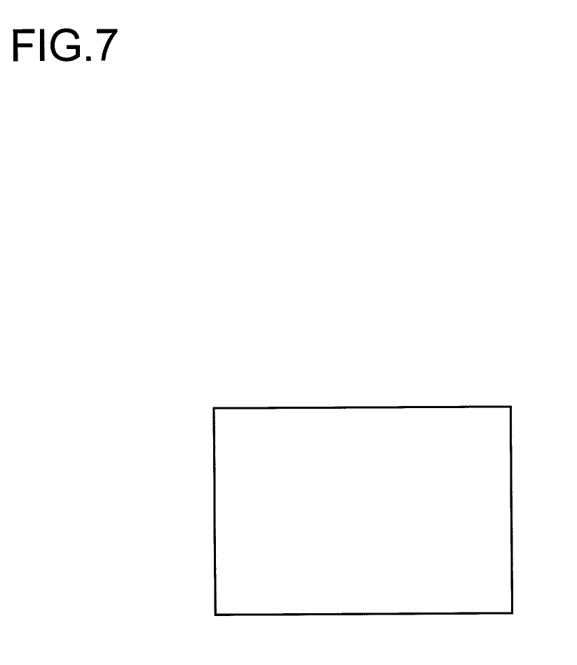

Exemplary embodiments of (i), (ii) and (iii) are shown in FIGS. 1 to 7. FIGS. 1 and 2 show the core (iii), which has four edges (v) which extend over the total length of (iii), parallel to the longitudinal axis of (iii). The external dimensions of (iii) are such that (iii) fits into recesses in the inner cavity (vi) of (ii). The bearing element (ii) is shown in FIGS. 3, 4 and 5. The inner cavity (vi), which receives (iii), is shown in FIGS. 4 and 5. The outer surface of (ii) has recesses (vii) and edges (viii) which lead to interlocking of (ii) with (i). These edges (viii) and recesses (vii) are preferably arranged parallel to the longitudinal axis of (ii) and are clearly shown in FIG. 5. FIGS. 6 and 7 show the sleeve (i), which is hollow. The cavity (ix) of (i) has contours in the form of edges (x) and recesses (xi) which are formed in such a way that (ii) is fixed in the cavity (ix) of (i) and a rotational movement of (ii) in relation to (i) about the common longitudinal axis is limited to the extent permitted by the resiliences of the material of (ii). (iii) and (ii) do not have to completely fill the cavity of (ii) and (i), respectively. It is sufficient if their respective edges are fitted at least partly into the corresponding recessses of the outer component. The collars present at the top and bottom on (ii) prevent the connecting element from being separated in its longitudinal direction, after pressing it, under the action of a force which is smaller than the specified value.

A connecting element which comprises (i) sleeve, (ii) bearing element and (iii) core is preferred, the core (iii) having, on the outer surface, edges (v) which extend over the total length of (iii), parallel to the longitudinal axis of (iii), preferably the external dimensions of (iii) being such that (iii) fits exactly into the inner cavity (vi) of (ii), the bearing element (ii) having, in the surface facing the cavity (vi), recesses (xii) for receiving the edges (v), the outer surface of (ii) having recesses (vii) and edges (viii) which lead to interlocking of (ii) with (i), the edges (viii) and recesses (vii) being arranged parallel to the longitudinal axis of (ii), the sleeve (i) being hollow, the cavity (ix) of (i) having contours in the form of edges (x) and recesses (xi) which are formed in such a ay that (ii) can be fixed in the cavity (ix) of (i) and a rotational movement of (ii) in relation to (i) about the common longitudinal axis can be prevented.

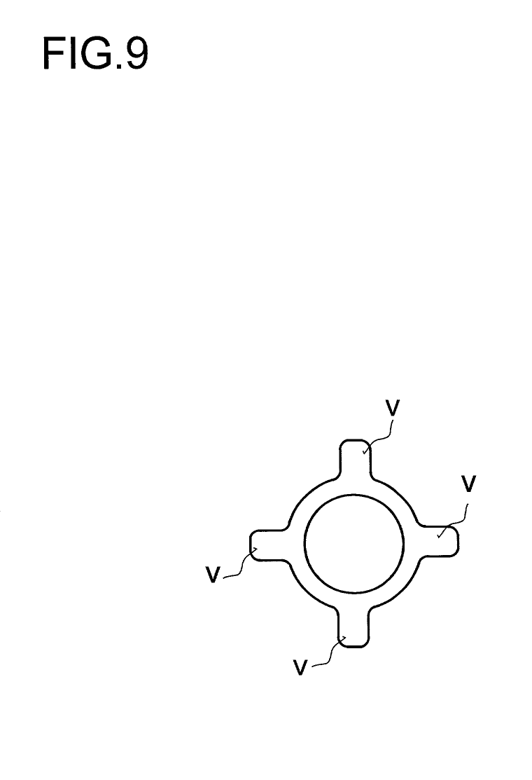

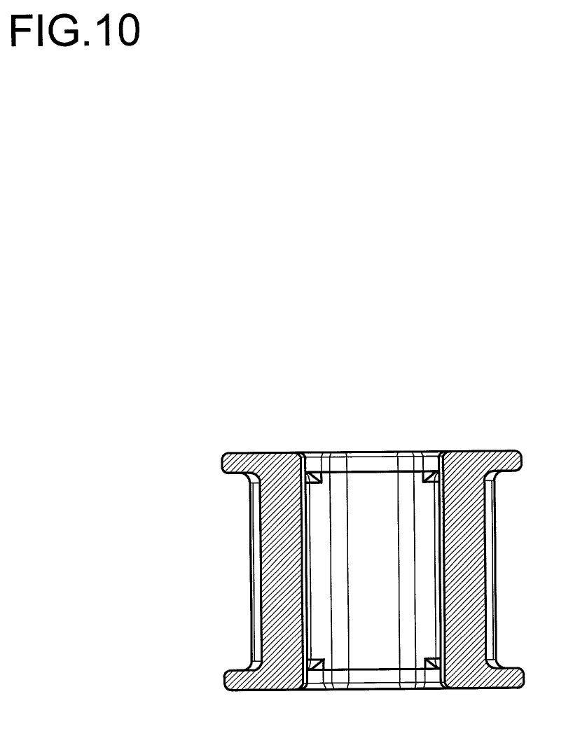

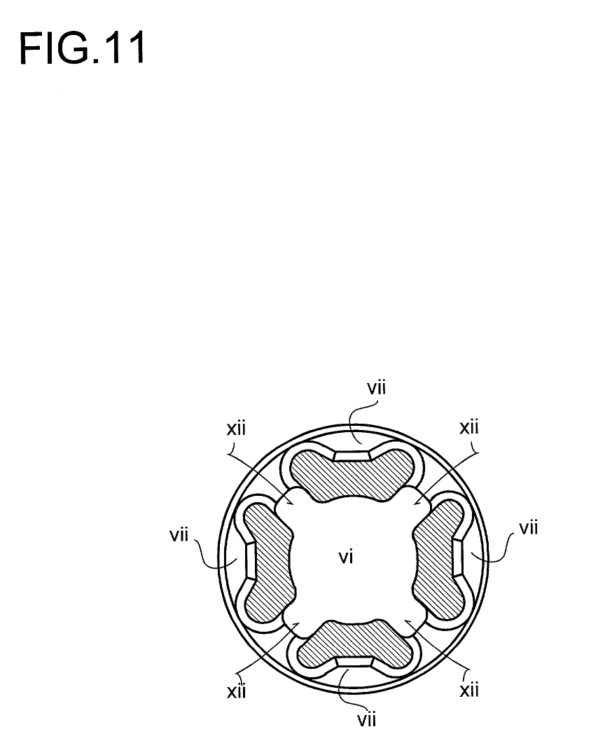

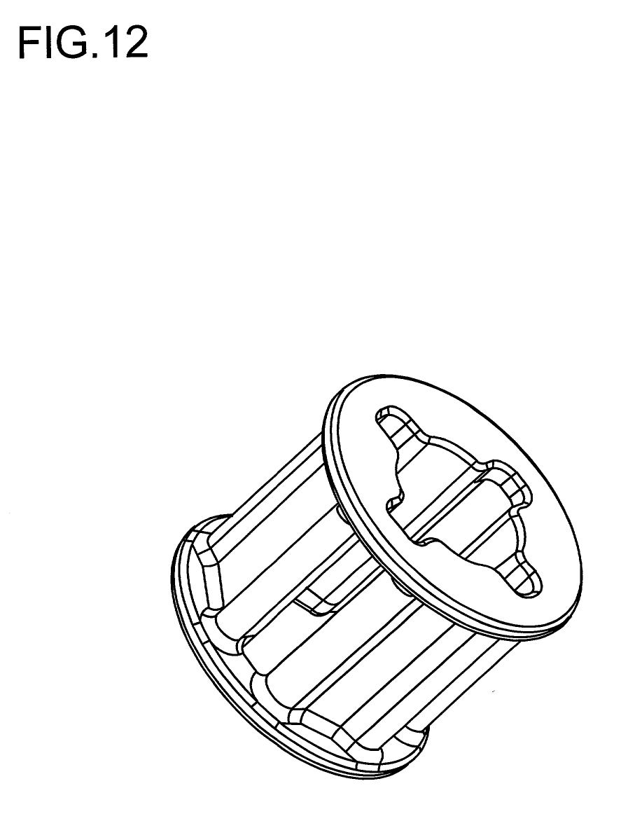

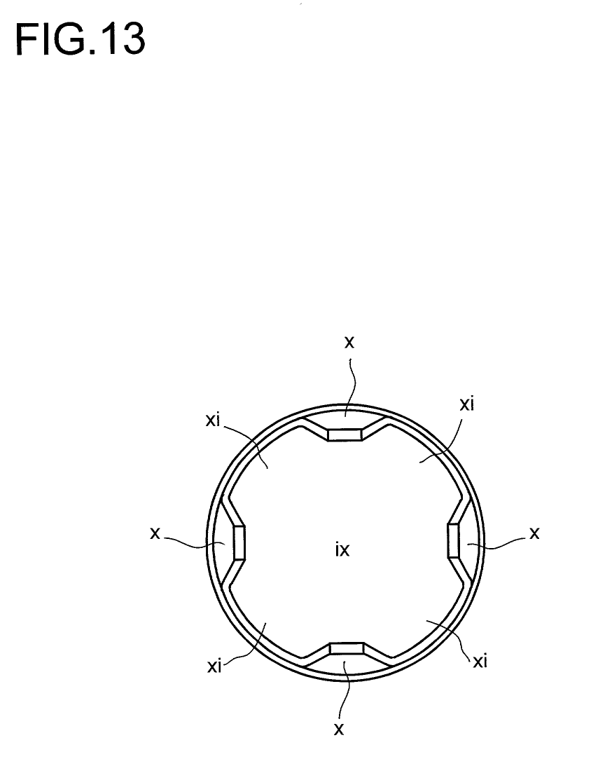

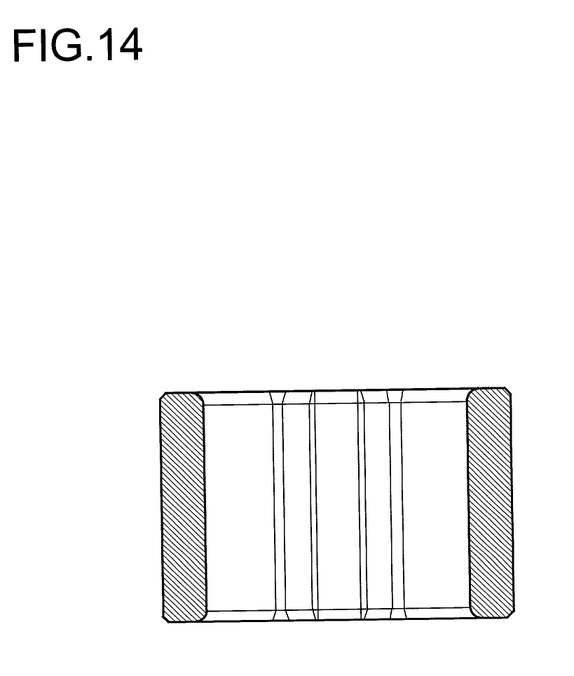

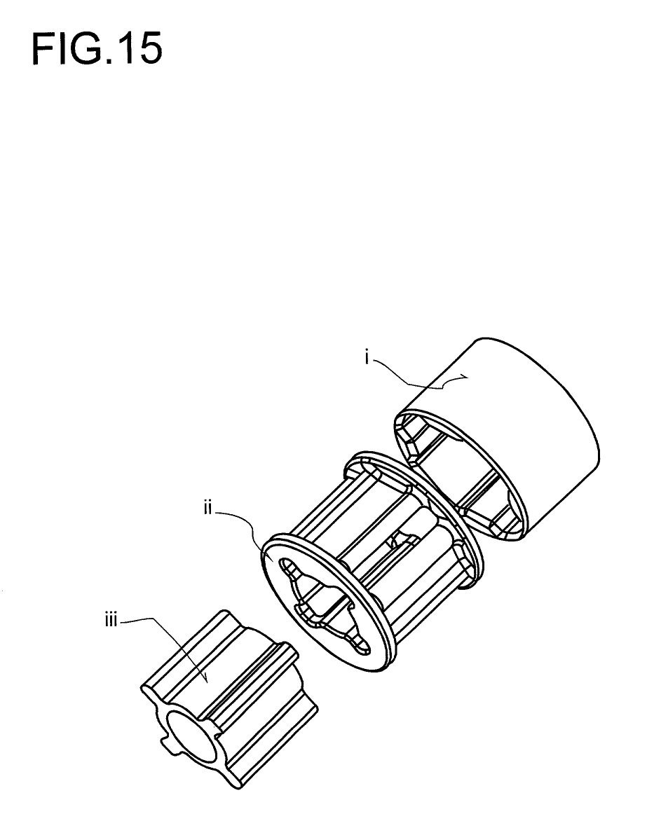

A further possible and preferred embodiment of a novel connecting element is shown in FIGS. 9 to 15, the reference symbols stated for the above figures also applying to these figures. FIG. 9 accordingly shows a core (iii), FIGS. 10, 11 and 12 a bearing element (ii), and FIGS. 13 and 14 a sleeve (i) and FIG. 15 shows an overview of a connecting element.

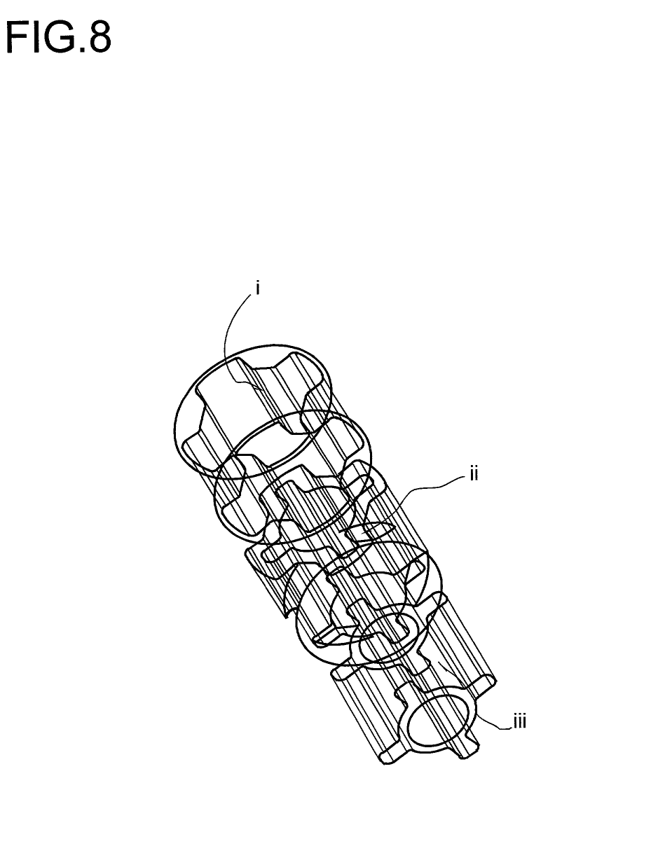

Both the three-dimensional shape shown in the figures and the dimensions stated in the figures are merely one possible embodiment of a novel connecting element. The stated lengths in the figures have the unit mm. FIG. 8 shows the arrangement of the components (i), (ii) and (iii) in the connecting element.

Furthermore, preferred connecting elements are those in which (ii) is based on cellular polyisocyanate polyadducts, particularly preferably based on cellular polyurethane elastomers which may contain polyurea structures, in particular based on cellular polyurethane elastomers having a density, according to DIN 53420, of from 200 to 1100, preferably from 300 to 800 kg/m³, a tensile strength according to DIN 53571 of >2, preferably from 2 to 8 N/mm², an elongation, according to DIN 53571, of >300, preferably from 300 to 700, % and a tear propagation strength, according to DIN 53515, of >8, preferably from 8 to 25 N/mm. Cellular polyisocyanate polyadducts are generally known to a person skilled in the art. They have the particular advantage that distortions between (i) and (iii) can be absorbed and reduced by (ii).

The components (i) and (iii) are usually produced from metal or plastic, preferably from metal, for example from steel, iron, aluminum or copper. Conventional alloys are also suitable.

The components (i), (ii) and (iii) can be produced separately from one another, in the case of (i) and (iii), for example, by injection molding of the plastics or by casting, punching or pressing of metals.

The connecting element can be assembled by pressing the elastomer spring (ii) into the sleeve (i) so that the collar is elastically deformed in the pressing-in process. After the collar has slipped through the sleeve, it relaxes again and prevents the elastomer spring from slipping out of the sleeve. The core (iii), which in turn can likewise be prevented from sliding back by undercuts in the inner contour of the elastomer spring, is then pressed in. Where forces which are greater than the retention power of the collar on the elastomer spring act in the longitudinal direction of the connecting element, stop disks additionally to be mounted can prevent the inner parts from slipping out of the sleeve. These stop disks can be firmly connected to the core in a corresponding manner.

However, the assembly of the components (i), (ii) and (iii) to give the novel connecting elements can also be effected by simply inserting, for example pushing, (iii) into (ii) and (ii) with (iii) into (i). The components (iii) and (ii) can be fixed in (i) by cover plates on or at the orifices to the cavity in (i) in which (ii) and (iii) are present. Preferably, (iii) too has a cavity parallel to its longitudinal axis, so that the connecting element has a continuous cavity parallel to its longitudinal axis. In this case the cover plates are provided with a corresponding hole so that the cavity is accessible.

The novel connecting elements can serve for connecting movable structural parts. For example, movable chassis parts, for example connecting rods, auxiliary frames, stabilizers and shock absorbers can be connected in such a way that the required freedom of movement is ensured and vibrations can be damped..

The novel connecting elements have the following advantages:

The bearing can be loaded radially, axially, cardanically and torsionally.

The rigidities in the three coordinate directions can differ very greatly depending on the geometric shape, in particular the support surfaces and choice of material of (ii).

As a result of the contouring, excellent transmission of torsional force is permitted without adhesion promoters, which transmission could be substantially improved in comparison with purely cylindrical moldings.

The novel bearing elements are usually based on natural or synthetic materials, for example rubber, preferably on elastomers based on polyisocyanate polyadducts, for example polyurethanes and/or polyureas, for example polyurethane elastomers, which may contain urea structures. Preferably, the elastomers are microcellular elastomers based on polyisocyanate polyadducts, preferably having cells with a diameter of from 0.01 mm to 0.5 mm, particularly preferably from 0.01 to 0.15 mm. Particularly preferably, the elastomers have the physical 15 properties described at the outset. Elastomers based on polyisocyanate polyadducts and their preparation are generally known and widely described, for example in EP-A 62 835, EP-A 36 994, EP-A 250 969, DE-A 195 48 770 and DE-A 195 48 771.

The preparation is usually carried out by reacting isocyanates with compounds reactive toward isocyanates.

The elastomers based on cellular polyisocyanate polyadducts are usually prepared in a mold, in which the reactive starting components are reacted with one another. Suitable molds are generally conventional molds, for example metal molds, which, owing to their shape, ensure the novel three-dimensional shape of the spring element.

The polyisocyanate polyadducts can be prepared by generally known processes, for example by using the following starting materials in a one-stage or two-stage process:

(a) isocyanate,

(b) compounds reactive toward isocyanates,

(c) water and, if required

(d) catalysts,

(e) blowing agents and/or

(f) assistants and/or additives, for example polysiloxanes and/or fatty acid sulfonates.

The temperature of the inner surface of the mold is usually from 40 to 95° C., preferably from 50 to 90° C.

The production of the shaped articles is advantageously carried out using an NCO/OH ratio of from 0.85 to 1.20, the heated starting components being mixed and being introduced into a heated, preferably tightly sealing mold, in an amount corresponding to the desired density of the shaped article.

The shaped articles are cured after from 5 to 60 minutes and can then be removed from the mold.

The amount of reaction mixture introduced into the mold is usually such that the moldings obtained have the density mentioned above.

The starting components are usually introduced into the mold at a temperature of from 15 to 120° C., preferably from 30 to 110° C. The degrees of densification for the production of the moldings are from 1.1 to 8, preferably from 2 to 6.

The cellular polyisocyanate polyadducts are expediently prepared by the one-shot process with the aid of the low pressure technique or in particular the reaction injection molding (RIM) technique in open or, preferably, closed molds. The reaction is 20 carried out in particular with densification in a closed mold. The reaction injection molding technique is described, for example, by H. Piechota and H. Röhr in Integralschaumstoffe, Carl Hanser-Verlag, Munich, Vienna 1975; D. J. Prepelka and J. L. Wharton in Journal of Cellular Plastics, March/April 1975, pages 87 to 98, und U. Knipp in Journal of Cellular Plastics, March/April 1973, pages 76-84.

When a mixing chamber having a plurality of feed nozzles is used, the starting components can be fed in individually and thoroughly mixed in the mixing chamber. It has been found to be advantageous to employ the two-component process.

According to a particularly advantageous embodiment, an NCO-containing prepolymer is first prepared in a two-stage process. For this purpose, the component (b) is reacted with (a) in excess, usually at from 80 to 160° C., preferably from 110 to 150° C. The reaction time is based on the achievement of the theoretical NCO content.

Accordingly, the novel production of the moldings is preferably effected in a two-stage process by preparing an isocyanate-containing prepolymer in the first stage by reacting (a) with (b) and reacting this prepolymer, in the second stage, in a mold, with a crosslinking component containing, if required, further components stated at the outset.

In order to improve the demolding of the vibration dampers, it has proven advantageous to coat the inner surfaces of the mold, at least at the beginning of a production series, with conventional external lubricants, for example based on wax or silicone, or in particular with aqueous soap solutions.

The mold residence times are on average from 5 to 60 minutes, depending on the size and geometry of the shaped article.

After the production of the shaped articles in the mold, the shaped articles can preferably be heated for from 1 to 48 hours at, usually, from 70 to 120° C.

Regarding the starting components for the preparation of the polyisocyanate polyadducts, the following may be stated: Isocyanates (a) which may be used are generally known

(cyclo)aliphatic and/or aromatic polyisocyanates. Particularly suitable for connecting the production of the novel elements are aromatic diisocyanates, preferably diphenylmethane 2,2′-, 2,4′- and/or 4,4′-diisocyanate (MDI), naphthylene 1,5-diisocyanate (NDI), tolylene 2,4- and/or 2,6-diisocyanate (TDI), dimethylbiphenyl 3,3′-diisocyanate (TODI), diphenylethane 1,2-diisocyanate and phenylene diisocyanate, and/or aliphatic isocyanates, e.g. dodecane 1,12-diisocyanate, 2-ethylbutane 1,4-diisocyanate, 2-methylpentane 1,5-diisocyanate, butane 1,4-diisocyanate and preferably hexamethylene 1,6-diisocyanate and/or cycloaliphatic diisocyanates, e.g. cyclohexane 1,3- and 1,4-diisocyanate, hexahydrotolylene 2,4- and 2,6-diisocyanate, dicyclohexylmethane 4,4′-, 2,4′- and 2,2′-diisocyanate, preferably 1-isocyanato-3,3,5-trimethyl-5-isocyanatomethylcyclohexane and/or polyisocyanates, e.g. polyphenylpolymethylene polyisocyanates. The isocyanates can be used in the form of the pure compound, as mixtures and/or in modified form, for example in the form of uretdiones, isocyanurates, allophanates or biurets, preferably in the form of reaction products containing urethane and isocyanate groups, i.e. isocyanate prepolymers. Unmodified or modified diphenylmethane 2,2′-, 2,4′- and/or 4,4′-diisocyanate (MDI), naphthylene 1,5-diisocyanate (NDI), dimethylbiphenyl 3,3′-diisocyanate (TODI), tolylene 2,4- and/or 2,6-diisocyanate (TDI) and/or mixtures of these isocyanates are preferably used.

Generally known polyhydroxy compounds, preferably those having a functionality of from 2 to 3 and preferably a molecular weight of from 60 to 6000, particularly preferably from 500 to 6000, in particular from 800 to 5000, can be used as compounds (b) reactive toward isocyanates. Polyether polyols, polyester polyalcohols and/or hydroxyl-containing polycarbonates are preferably used as (b).

Suitable polyether polyols can be prepared by known processes, for example by anionic polymerization with alkali metal hydroxides, e.g. sodium hydroxide or potassium hydroxide, or alkali metal alcoholates, e.g. sodium methylate, sodium ethylate, potassium ethylate or potassium isopropylate, as catalysts and with the addition of at least one initiator which contains 2 or 3, preferably 2, bonded reactive hydrogen atoms per molecule, or by cationic polymerization with Lewis acids, e.g. antimony pentachloride, boron fluoride etherate, etc., or bleaching earths as catalysts, from one or more alkylene oxides having 2 to 4 carbon atoms in the alkylene radical.

Suitable alkylene oxides are for example 1,3-propylene oxide, 1,2- and 1,3-butylene oxide, preferably ethylene oxide, 1,2-propylene oxide and tetrahydrofuran. The alkylene oxides may be used individually, alternately in succession or as a mixture. Examples of suitable initiator molecules are water, organic dicarboxylic acids, such as succinic acid, adipic acid, phthalic acid and terephthalic acid, aliphatic and aromatic, N-monoalkyl- and N,N′-dialkyl-substituted diamines having 1 to 4 carbon atoms in the alkyl radical, such as mono- and dialkyl-substituted ethylenediamine, 1,3-propylenediamine, 1,3- and 1,4-butylenediamine, 1,2-, 1,3-, 1,4-, 1,5- and 1,6-hexamethylenediamine, alkanolamines, e.g. ethanolamine, N-methyl- and N-ethylethanolamine, dialkanolamines, e.g. diethanolamine, N-methyl- and N-ethyldiethanolamine, and trialkanolamines, e.g. triethanolamine, and ammonia. Dihydric and/or trihydric alcohols are preferably used, for example alkanediols of 2 to 12, preferably 2 to 4, carbon atoms, such as ethanediol, 1,2- and 1,3-propanediol, 1,4-butanediol, 1,5-pentanediol, 1,6-hexanediol, glycerol, and trimethylolpropane, and dialkylene glycols, such as diethylene glycol and dipropylene glycol.

Polyester polyalcohols, also referred to below as polyester 40 polyols, are preferably used as (b). Suitable polyester polyols can be prepared, for example, from dicarboxylic acids of 2 to 12 carbon atoms and dihydric alcohols. Examples of suitable dicarboxylic acids are aliphatic dicarboxylic acids, such as succinic acid, glutaric acid, adipic acid, suberic acid, azelaic acid and sebacic acid, and aromatic dicarboxylic acids, such as phthalic acid, isophthalic acid and terephthalic acid. The dicarboxylic acids can be used individually or as mixtures. For the preparation of the polyester polyols, it may be advantageous, instead of the carboxylic acid, to use the corresponding carboxylic acid derivatives, such as carboxylic esters having 1 to 4 carbon atoms in the alcohol radical, carboxylic anhydrides or carbonyl chlorides. Examples of dihydric alcohols are glycols of 2 to 16, preferably 2 to 6, carbon atoms, e.g. ethylene glycol, diethylene glycol, 1,4-butanediol, 1,5-pentanediol, 1,6-hexanediol, 1,10-decanediol, 2-methylpropane-1,3-diol, 2,2-dimethylpropane-1,3-diol, 1,3-propanediol and dipropylene glycol. Depending on the desired properties, the dihydric alcohols can be used alone or, if required, as mixtures with one another.

Preferably used polyester polyols are ethanediol polyadipates, 1,4-butanediol polyadipates, ethanediol butanediol polyadipates, 1,6-hexanediol neopentylglycol polyadipates, 1,6-hexanediol 1,4-butanediol polyadipates, 2-methyl-1,3-propanediol 1,4-butanediol polyadipates and/or polycaprolactones.

Suitable polyoxyalkylene glycols containing ester groups, substantially polyoxytetramethylene glycols, are polycondensates of organic, preferably aliphatic dicarboxylic acids, in particular adipic acid with polyoxymethylene glycols having a number average molecular weight of from 162 to 600 and, if required, aliphatic diols, in particular 1,4-butanediol. Other suitable polyoxytetramethylene glycols containing ester groups are those polycondensates formed from the polycondensation with e-caprolactone.

Suitable polyoxyalkylene glycols containing carbonate groups, substantially polyoxytetramethylene glycols, are polycondensates of these with alkyl or aryl carbonates or phosgene.

Exemplary embodiments relating to the component (b) are given in DE-A 195 48 771, page 6, lines 26 to 59.

In addition to the components described above and reactive toward isocyanates, low molecular weight chain extenders and/or crosslinking agents (b1) having a molecular weight of less than 500, preferably from 60 to 499, may also be used, for example those selected from the group consisting of the di- and/or trifunctional alcohols, di- to tetrafunctional polyoxyalkylene polyols and the alkyl-substituted aromatic diamines or mixtures of at least two of said chain extenders and/or crosslinking agents.

For example, alkanediols of 2 to 12, preferably 2, 4 or 6, carbon atoms can be used as (b1), e.g. ethanediol, 1,3-propanediol, 1,5-pentanediol, 1,6-hexanediol, 1,7-heptanediol, 1,8-octanediol, 1,9-nonanediol, 1,10-decanediol and preferably 1,4-butanediol, dialkylene glycols of 4 to 8 carbon atoms, e.g. diethylene glycol and dipropylene glycol and/or di- to tetrafunctional polyoxyalkylene polyols.

However, branched and/or unsaturated alkanediols having, usually, not more than 12 carbon atoms are also suitable, e.g. 1,2-propanediol, 2-methyl-1,3-propanediol, 2,2-dimethyl-1,3-propanediol, 2-butyl-2-ethyl-1,3-propanediol, but-2-ene-1,4-diol and but-2-yne-1,4-diol, diesters of terephthalic acid with glycols of 2 to 4 carbon atoms, e.g. bisethylene glycol terephthalate or 1,4-butanediol terephthalate, hydroxyalkylene ethers of hydroquinone or resorcinol, such as 1,4-di(b-hydroxyethyl)hydroquinone or 1,3-di(b-hydroxyethyl)resorcinol, alkanolamines of 2 to 12 carbon atoms, such as ethanolamine, 2-aminopropanol and 3-amino-2,2-dimethylpropanol, N-alkyldialkanolamines, e.g. N-methyl- and N-ethyl-diethanolamine.

Examples of crosslinking agents (b1) having a higher functionality are trifunctional alcohols and alcohols having higher functionality, e.g. glycerol, trimethylolpropane, pentaerythritol and trihydroxycyclohexanes, and trialkanolamines, such as triethanolamine.

The following may be used as chain extenders: alkyl-substituted aromatic polyamines having molecular weights of, preferably, from 122 to 400, in particular primary aromatic diamines which have, ortho to the amino groups, at least one alkyl substituent which reduces the reactivity of the amino group by steric hindrance, and which are liquid at room temperature and are at least partly but preferably completely miscible with the higher molecular weight, preferably at least difunctional compounds (b) under the processing conditions.

The industrially readily available 1,3,5-triethyl-2,4-phenylenediamine, 1-methyl-3,5-diethyl-2,4-phenylenediamine, mixtures of 1-methyl-3,5-diethyl-2,4- and -2,6-phenylenediamines, i.e. DETDA, isomer mixtures of 3,3′-di- or 3,3′,5,5′-tetraalkyl-substituted 4,4°-diaminodiphenylmethanes having 1 to 4 carbon atoms in the alkyl radical, in particular 3,3′,5,5′-tetraalkyl-substituted 4,4′-diaminodiphenylmethane containing bonded methyl, ethyl and isopropyl radicals, and mixtures of said tetraalkyl-substituted 4,4′-diaminodiphenylmethanes and DETDA may be used to prepare the novel moldings.

For achieving specific mechanical properties, it may also be expedient to use the alkyl-substituted aromatic polyamines in a mixture with the abovementioned low molecular weight polyhydric alcohols, preferably dihydric and/or trihydric alcohols or dialkylene glycols.

Preferably, however, aromatic diamines are not used. The preparation of the novel products is therefore preferably carried out in the absence of aromatic diamines.

The preparation of the cellular polyisocyanate polyadducts can preferably be carried out in the presence of water (c). The water acts both as a crosslinking agent with formation of urea and, owing to the reaction with isocyanate groups, with formation of carbon dioxide as a blowing agent. Owing to this dual function, it is mentioned in this document separately from (e) and (b). By definition, the components (b) and (e) thus contain no water which is mentioned by definition exclusively as (e).

The amounts of water which can expediently be used are from 0.01 to 5, preferably from 0.3 to 3.0, % by weight, based on the weight of the component (b). The water can be used completely or partly in the form of the aqueous solutions of the sulfonated fatty acids.

In order to accelerate the reaction, generally known catalysts (d) may be added to the reaction batch, both during the preparation of a prepolymer and, if required, during the reaction of a prepolymer with a crosslinking component. The catalysts (d) can be added individually and as a mixture with one another. They are preferably organometallic compounds, such as tin(II) salts of organic carboxylic acids, e.g. tin(II) dioctoate, tin(II) dilaurate, dibutyltin diacetate and dibutyltin dilaurate, and tertiary amines, such as tetramethylethylenediamine, N-methylmorpholine, diethylbenzylamine, triethylamine, dimethylcyclohexylamine, diazabicyclooctane, N,N′-dimethylpiperazine, N-methyl-N′-(4-N-dimethylamino)butylpiperazine, N,N,N′,N″,N″-pentamethyldiethylenediamine or the like.

Other suitable catalysts are: amidines, e.g. 2,3-dimethyl-3,4,5,6-tetrahydropyrimidine, tris(dialkylaminoalkyl)-s-hexahydrotriazines, in particular tris(N,N-dimethylaminopropyl)-s-hexahydrotriazine, tetraalkylammonium hydroxides, e.g. tetramethylammonium hydroxide, alkali metal hydroxides, e.g. sodium hydroxide and alkali metal alcoholates, e.g. sodium methylate and potassium isopropylate, and alkali metal salts of long-chain fatty acids having 10 to 20 carbon atoms and, if required, OH side groups.

Depending on the reactivity to be established, the catalysts (d) are used in amounts of from 0.001 to 0.5% by weight, based on the prepolymer.

If required, conventional blowing agents (e) may be used in the polyurethane preparation. For example, low-boiling liquids which evaporate under the influence of the exothermic polyaddition reaction are suitable. Suitable liquids are those which are inert to the organic polyisocyanate and have boiling points below 100° C. Examples of such preferably used liquids are halogenated, preferably fluorinated, hydrocarbons, e.g. methylene chloride and dichloromonofluoromethane, perfluorinated or partially fluorinated hydrocarbons, e.g. trifluoromethane, difluoromethane, difluoroethane, tetrafluoroethane and heptafluoropropane, hydrocarbons, such as n-butane, isobutane, n-pentane and isopentane and the industrial mixtures of these hydrocarbons, propane, propylene, hexane, heptane, cyclobutane, cyclopentane and cyclohexane, dialkyl ethers, e.g. dimethyl ether, diethyl ether and furan, carboxylic esters, such as methyl and ethyl formate, ketones, such as acetone, and/or fluorinated and/or perfluorinated, tertiary alkylamines, e.g. perfluorodimethylisopropylamine. Mixtures of these low-boiling liquids with one another and/or with other substituted or unsubstituted hydrocarbons may also be used.

The most expedient amount of low-boiling liquid for the preparation of such cellular resilient moldings from elastomers containing bonded urea groups depends on the density which it is intended to achieve and on the amount of water preferably concomitantly used. In general, amounts of from 1 to 15, preferably from 2 to 11, % by weight, based on the weight of the component (b), give satisfactory results. Particularly preferably, exclusively water (c) is used as a blowing agent.

In the novel preparation of the shaped articles, assistants and additives (f) may be used. These include, for example, generally known surfactants, hydrolysis stabilizers, fillers, antioxidants, cell regulators, flameproofing agents and dyes. Suitable surfactants are compounds which serve for promoting the homogenization of the starting materials and may also be suitable for regulating the cell structure. Examples are compounds, in addition to the emulsifiers according to the invention, which have an emulsifying effect, such as the salts of fatty acids with amines, for example of oleic acid with diethylamine, of stearic acid with diethanolamine, of ricinoleic acid with diethanolamine, salts of sulfonic acids, for example alkali metal or ammonium salts of dodecylbenzene- or dinaphthylmethanedisulfonic acid. Foam stabilizers, for example oxethylated alkylphenols, oxethylated fatty alcohols, liquid paraffins, castor oil esters or ricinoleic esters, Turkey red oil and peanut oil, and cell regulators such as paraffins and fatty alcohols, are also suitable. Polysiloxanes and/or fatty acid sulfonates may also be used as (f). The polysiloxanes used may be generally known compounds, for example polymethylsiloxanes, polydimethylsiloxanes and/or polyoxyalkylene/silicone copolymers. The polysiloxanes preferably have a viscosity of from 20 to 2000 mPa.s at 25° C.

The fatty acid sulfonates used may be generally known sulfonated fatty acids, which are also available commercially. A preferably used fatty acid sulfonate is sulfonated castor oil.

The surfactants are usually used in amounts of from 0.01 to 5 parts by weight, based on 100 parts by weight of components (b).

1. A connecting element comprising (i) sleeve, (ii) bearing element and (iii) core, wherein (ii) has in each case an interlocking connection on the outer surface of (ii) with (i) and on the inner surface of (ii) with (iii).

2. A connecting element as claimed in claim 1, wherein (ii) is based on cellular polyisocyanate polyadducts.

3. A connecting element as claimed in claim 1, wherein (ii) and (iii) each have at least two edges which are positioned in corresponding grooves of (i) and (ii), respectively, and effect force transmission between (i), (ii) and (iii) during a rotational movement about the longitudinal axis of the connecting element.

4. A connecting element as claimed in claim 1, wherein (i), (ii) and (iii) are not bonded to one another by chemical reaction.

5. A connecting element as claimed in claim 1, wherein (i) and (ii) are hollow, (ii) is positioned by being pushed into the cavity of (i) and (iii) is positioned by being pushed into the cavity of (ii).
